(19) United States
(12) Patent Application Publication
(10) Pub. No.: US 2012/0124186 A1
(43) Pub. Date: May 17, 2012

(54) SYSTEMS, DEVICES, AND METHODS FOR MULTIPLE HOST MANAGEMENT

(76) Inventors: Theodore F. Emerson, Tomball, TX (US); David F. Heinrich, Tomball, TX (US); Don A. Dykes, Houston, TX (US); Robert L. Noonan, Crystal Lake, IL (US); Dwight D. Riley, Houston, TX (US)

(21) Appl. No.: 12/946,540

(22) Filed: Nov. 15, 2010

(51) Int. Cl. G06F 15/173

(52) U.S. Cl. 709/223

(57) ABSTRACT

Methods, devices, and systems for multiple host management are provided. An example of a method for multiple host management includes a multiple host management device managing a plurality of host instances. The multiple host management device can provide each of the plurality of host instances with a plurality of input/output (I/O) functionalities.

### BACKGROUND

Demand for higher density compute resources has increased. Unlike those computer systems that include one or more processors functioning under the control of a single operating system, a multiple host (multi-host) distributed computer system typically includes multiple hosts, each including one or more processors, each running under the control of a separate operating system. An example of a host can include a single blade in a blade server. A single blade may comprise a separate computing system (e.g., including processor and memory resources, video processing, and other input/output functionality). Platform management subsystems (e.g., a baseboard management controller, BMC) may be architected to manage a single host.

Some previous approaches to management processor subsystems are closely coupled to a particular host to redirect remote keyboard, video, and mouse (KVM) functionality, remote virtual media services, and/or other management functions. Interconnect devices (e.g., peripheral component interconnect, PCI devices) may be assigned input/output (I/O) and memory resources belonging to a single host and single address space. To make a complete compute instance, previous approaches have included legacy I/O components (e.g., southbridge, video, serial I/O, and/or flash, among others) for each logical server instance. Additionally, internal circuitry designed to detect certain host events (e.g., server reset, server power, and server thermals) may be designed with the assumption there is one and only one host to be managed. One complete management subsystem may typically be supplied for each logical host (e.g., server) instance (e.g., each compute blade in an enclosure may contain its own independent management subsystem).

Some previous approaches may attempt to reduce the number of management subsystems supporting multiple hosts (e.g., compute nodes) through sharing of a management subsystem by placing multiplexers in front of various connections to the hosts. For instance, a multiplexer may be placed in front of the video output stream and/or on a universal serial bus (USB) device connection. The management processor may then select a host to manage.

### BRIEF DESCRIPTION OF THE DRAWINGS

FIG. 1 illustrates a block diagram of an example of a system for multiple host management according to the present disclosure.

FIG. 2A illustrates a block diagram of an example of a system for multiple host management including multiple buses according to the present disclosure.

FIG. 2B illustrates a block diagram of an example of a system for multiple host management including a shared bus according to the present disclosure.

FIG. 3 illustrates a block diagram of an example of a system for multiple host management including remote access and control according to the present disclosure.

FIG. 4 provides a block diagram illustrating an example of a method for multiple host management according to the present disclosure.

### DETAILED DESCRIPTION

Embodiments of the present disclosure include methods, devices, and systems for multiple host management. An example of a method for multiple host management includes a multiple host management device managing a plurality of host instances. The multiple host management device can provide each of the plurality of host instances with a plurality of input/output (110) functionalities.

The model of one management hardware device per host (e.g., server) has become disadvantageous due to cost and power usage of multiple host instances. Those previous approaches using multiplexers to reduce the number of hardware instances, besides adding additional cost and componentry to the platform, have forced the management subsystem to choose which host to manage and which host(s) to ignore. Furthermore, including I/O components with each host involves duplication of several costly subsystems that take board real-estate and power. Some of these issues can be addressed via computer executable instructions (e.g., software), however, the involved changes are extensive and impact the platform's static executable instructions (e.g., firmware such as read only memory, ROM), operating system (OS) drivers, and perhaps even the OS kernel itself. Additionally, such previous approaches that address the issue with software may preclude an “out of the box” experience for the customer and create a vendor proprietary operating environment.

Examples of the present disclosure can provide for management of a machine that contains multiple virtual and/or physical hosts (e.g., server instances) and provide each host with a compliment of I/O functionalities. Devices such as ROMs can be virtualized to each logical host instance and be backed by a management processor in various forms (e.g., the management processor can serve as a virtual ROM server by fetching system ROM images from a network repository and serving it to a particular host). Furthermore, examples of the present disclosure can provide for “absorbing” peripherals over time, allowing a phased approach to a complete solution. For example, a first implementation can eliminate separate ROMs from each host interface, and a later implementation can eliminate other previously duplicated peripherals. That is, over time, more host functionalities can be absorbed by a multi-host management device. Examples of the present disclosure can reduce the total amount of logic, board real-estate, and power consumed as compared to those previous approaches that included a full complement of peripherals associated with each host instance. As used herein, “logic” implies hardware (e.g., various forms of transistor logic, application specific integrated circuits, ASICs, etc.), as opposed to computer executable instructions (e.g., software, firmware, etc.) stored in memory and executable by a processor. Likewise, total system cost in terms of both fabrication and operation are reduced.

In the detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the embodiments of this disclosure, and it is to be understood that other examples may be utilized and that process, electrical, and/or structural changes may be made without departing from the scope of the present disclosure. As used herein, the designators “N” and “M” including reference numerals in the drawings, indicate that a number of the particular feature so designated can be included with examples of the present disclosure. The designators can represent the same or different numbers of the particular features.

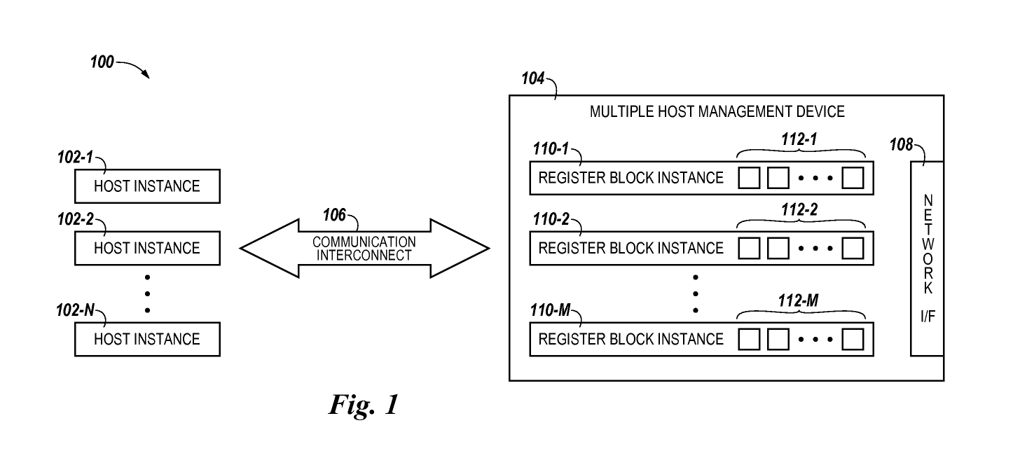

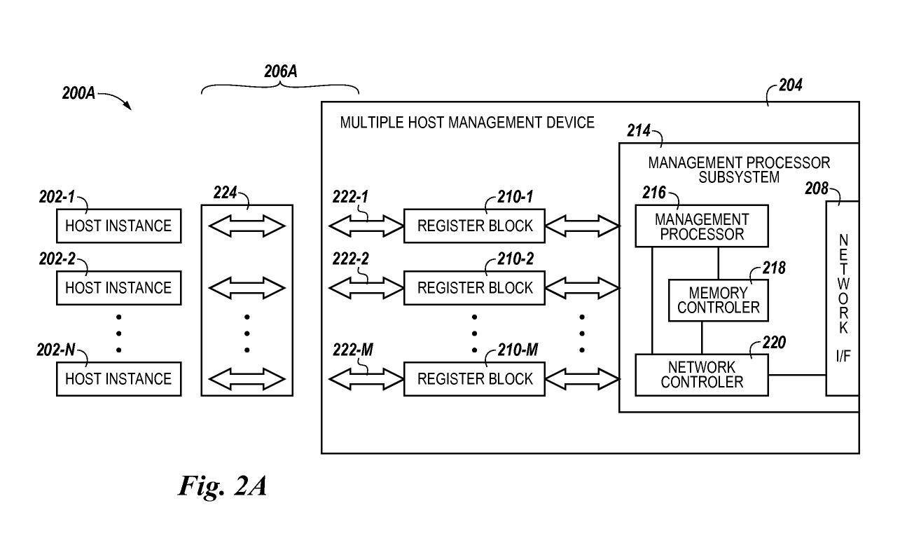

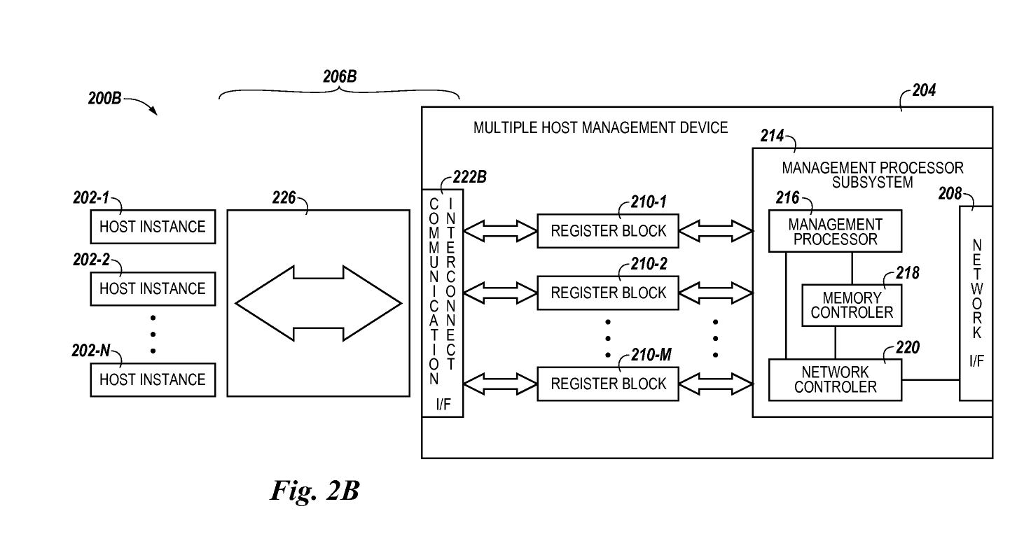

The figures herein follow a numbering convention in which the first digit or digits correspond to the drawing figure number and the remaining digits identify an element or component in the drawing. Similar elements or components between different figures may be identified by the use of similar digits. For example, 104 may reference element “04” in FIG. 1, and a similar element may be referenced as 204 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

FIG. 1 illustrates a block diagram of an example of a system 100 for multiple host (multi-host) management according to the present disclosure. The system 100 can include multiple host instances 102-1, 102-2, . . . , 102-N. The system 100 can include a multiple host (multi-host) management device 104 coupled to the host instances 102-1, 102-2, . . . , 102-N by a communication interconnect 106.

The multiple host instances 102-1, 102-2, . . . , 102-N can be different server partitions, virtual machines within a server, different servers, and/or hardware platforms, etc. For example, the multiple host instances 102-1, 102-2, . . . , 102-N can be server blades in a rack server. In some examples of the present disclosure, the multiple host instances 102-1, 102-2, . . . , 102-N can be server nodes coupled to a backplane of a rack server. A backplane can be a power distribution board to distribute power and/or electrical signals to electronic machines (e.g., server blades) and can take the form of a printed circuit board (PCB). For example, the backplane can include and/or be coupled to the communication interconnect 106 and the multiple host management device 104, where the multi-host management device 104 comprises an application specific integrated circuit (ASIC). At least one of the multiple host instances 102-1, 102-2, . . . , 102-N does not include legacy I/O hardware. In some examples, none of the multiple host instances include legacy I/O hardware. In some examples, a particular host instance (e.g., host instance 202-1) can be a physical server including more than one virtual machine (e.g., virtual server), where the particular host instance can include a hypervisor that can run an operating system for each virtual machine concurrently on the particular host instance.

The multi-host management device 104 can include a network interface 108 (e.g., a physical layer, PHY, interface) and a plurality of host register block instances 110-1, 110-2, . . . , 110-M. Each of the plurality of host register block instances 110-1, 110-2, . . . , 110-M can correspond to a particular one of the plurality of host instances 102-1, 102-2, . . . , 102-N (e.g., host register block instance 110-1 can correspond to a respective host instance 102-1), however examples are not so limited. In some examples, one host register block instance (e.g., host register block instance 110-1) can correspond to more than one host instance (e.g., host instances 102-1 and 102-2). In some examples, more than one host register block instance (e.g., host register block instances 110-1 and 110-2) can correspond to one host instance (e.g., host instance 102-1). The number represented by “N” in host instance 102-N can be the same or different than the number represented by “M” in host register block instance 110-M. As described herein, a particular host instance (e.g., host instance 102-1) can include one physical machine and/or multiple virtual machines associated with a physical machine (e.g., server).

The host register block instances 110-1, 110-2, . . . , 110-M can include aspects of a management subsystem that are host-specific (e.g., PCI registers, power control, device emulation, etc.). The host-specific aspects can be partitioned into the host register block instances 110-1, 110-2, . . . , 110-M. The multi-host management device 104 (e.g., including a management processor subsystem 214 as described with respect to FIGS. 2A-2B) can include management hardware and/or firmware that interacts with the host register block instances 110-1, 110-2, . . . , 110-M to provide management, control, and/or I/O functionality for the plurality of host instances 102-1, 102-2, . . . , 102-N.

Each of the plurality of host register block instances 110-1, 110-2, . . . , 110-M can include a number of legacy I/O devices 112-1, 112-2, . . . , 112-M for use in association with the host instances 102-1, 102-2, . . . , 102-N. As used herein, legacy I/O devices can include a collection of I/O peripherals and/or logic that can be used to boot, operate, and/or manage a computing device. The term “legacy” does not infer a particular amount of time that the device has been a part of a machine's architecture.

As illustrated, the number of legacy I/O devices 112-1 included with the register block instance 110-1, the number of legacy I/O devices 112-2 included with the register block instance 110-2, and the number of legacy I/O devices 112-M included with the register block instance 110-M each include a number of boxes that are not individually labeled. The number of boxes indicate that a number of legacy I/O devices can be included with each register block instance 110-1, 110-2, . . . , 110-M. However, the number of and/or type of I/O devices included with each register block instance 110-1, 110-2, . . . , 110-M are not required to be the same according to various examples of the present disclosure.

The legacy I/O devices 112-1, 112-2, . . . , 112-M can include emulation registers, complete non-emulated devices (e.g., an interrupt controller), completely emulated devices (e.g., a virtual universal asynchronous receiver/transmitter, UART), placebo registers, and/or hybrid devices, which can be a device that is partially emulated (e.g., a USB host controller, some legacy I/O components, among others). For example, a legacy I/O device 112-1 comprising a video engine can be implemented with circuitry (e.g., hardware) on the register block instance 110-1 and share memory and display resources. For example, a legacy I/O device 112-1 comprising an interrupt controller can be implemented with circuitry on the register block instance 110-1 and not share resources. For example, a legacy I/O device 112-1 comprising a virtual UART can be implemented with both circuitry and emulation (e.g., software) on the register block instance 110-1 and not share resources. For example, a legacy I/O device 112-1 comprising a virtual USB host can be implemented with circuitry and emulation on the register block instance 110-1 and not share resources. For example, a legacy I/O device 112-1 comprising a DMA controller can be implemented with placebo registers on the register block instance 110-1 and not share resources. For example, a legacy I/O device 112-1 comprising a ROM can be implemented without emulation via the register block instance 110-1 by sharing the ROM image. For example, a legacy I/O device 112-1 comprising an RTC can be implemented with circuitry and emulation on the register block instance 110-1 and share a central calendar time reference.

According to examples of the present disclosure, the legacy I/O devices 112-1, 112-2, . . . , 112-M “appear” as though they are hardware devices from the perspective of the host instances 102-1, 102-2, . . . , 102-N. In some examples, the legacy 110 devices 112-1, 112-2, . . . , 112-M can be implemented in logic. The legacy I/O devices 112-1, 112-2, . . . , 112-M can be backed by a number of management processors (e.g., management processor 216 illustrated in FIGS. 2A-2B), which can provide various levels of intelligence thereto. The legacy 410 devices 112-1, 112-2, . . . , 112-M may be operationally coupled to the logically attached host instances 102-1, 102-2, . . . , 102-N and/or other logic contained in the multi-host management device 104. The legacy I/O devices 112-1, 112-2, . . . , 112-M can initiate and/or receive transactions across the communication interconnect 106. The legacy I/O devices 112-1, 112-2, . . . , 112-M can initiate and/or receive transactions with other logic in the multiple host management device 104. The legacy I/O devices 112-1, 112-2, . . . , 112-M can generate notification events consistent with a particular device being emulated to the logically attached host instance 102-1, 102-2, . . . , 102-N and/or the management processor (e.g., management processor 216 as illustrated in FIGS. 2A-2B). Although various functionalities are described herein as being provided collectively to the host instances 102-1, 102-2, . . . , 102-N, examples are not so limited as functionalities can be provided to the host instances 102-1, 102-2, . . . , 102-N on an individual basis (e.g., certain functionalities can be provided to some, but not all of the host instances 102-1, 102-2, . . . , 102-N).

In some examples, the legacy I/O devices 112-1, 112-2, . . . , 112-M can provide at least partial access for the host instances 102-1, 102-2, . . . , 102-N to a device on the multi-host management device 104 that is not specifically included in the host register block instances 110-1, 110-2, . . . , 110-M. For example, the multi-host management device 104 can include a real-time clock (RTC) where a legacy I/O device 112-1, 112-2, . . . , 112-M can provide shared access to the RTC (e.g., access to time and calendar information) for the host instances 102-1, 102-2, . . . , 102-N. As another example, the multi-host management device 104 can include memory resources (not specifically illustrated) that can be allocated to the host register block instances 110-1, 110-2, . . . , 110-M to augment a number of the legacy I/O devices 112-1, 112-2, . . . , 112-M. The multiple host management device 104 can assign a portion of the memory resources available to the management device 104 to a host register block instance 110-1, 110-2, . . . , 110-M. Memory resource portions can be assigned based on configuration registers included in the register block instances 110-1, 110-2, . . . , 110-M.

The number of legacy I/O devices 112-1, 112-2, . . . , 112-M can include I/O registers (e.g., legacy I/O registers) implemented with varying degrees of emulation. I/O registers can provide I/O functionality to each of the host instances 102-1, 102-2, . . . , 102-N. Legacy I/O functionality can include keyboard communication, video communication, mouse communication, serial communication, and parallel communication, functionalities associated with a southbridge chip, functionalities associated with a super I/O ASIC, and/or flash, among others. Southbridge chip functionalities can include, for example, peripheral component interconnect (PCI) and/or peripheral component interconnect express (PCI-E), industry standard architecture (ISA), serial peripheral interface (SPI), system management bus (SMB), direct memory access (DMA), interrupt control, parallel advanced technology attachment (PATA), serial advanced technology attachment (SATA), real-time clock, power management, non-volatile basic integrated operating system (BIOS) memory, audio. and/or out-of-band management control, among others. Super I/O ASIC functionalities can include, for example, floppy disk controller, a parallel port, a number of serial ports, and/or a keyboard controller with keyboard and mouse interface, among others. Providing such devices with the multi-host management device 104 can be beneficial by allowing for the host instances 102-1, 102-2, . . . , 102-N to be provided with such I/O functionality without including physical I/O devices (e.g., super I/O and/or southbridge), thereby reducing the cost of implementing the host instances 102-1, 102-2, . . . , 102-N.

The number of legacy I/O devices 112-1, 112-2, . . . , 112-M can include placebo registers, which can create the appearance for the host instances 102-1, 102-2, . . . , 102-N that a particular device is included with the register block instances 110-1, 110-2, . . . , 110-M, but is idle. For example, placebo registers can include a set of DMA registers. An actual DMA device may not be supported in a particular implementation, but an operating system (OS) running on a particular host instance (e.g., host instance 102-1) may attempt to communicate with a DMA controller, thus the set of placebo DMA registers may be provided for compatibility with the host instance OS, although the set of placebo DMA registers may not perform actual DMA functions.

The number of legacy I/O devices 112-1, 112-2, . . . , 112-M can include devices that advantageously share resources of the multi-host management device 104 (e.g., a video controller for the host instances 102-1, 102-2, . . . , 102-N). Each host instance 102-1, 102-2, . . . , 102-N can be provided with a video controller instance via the register block instances 110-1, 110-2, . . . , 110-M and a frame buffer using other memory resources on the multi-host management device 104. For example, since frame buffers may typically use a relatively large amount of the memory resources, a greater bulk of memory resources can be provided for the multi-host management device 104 to use among the number of register block instances 110-1, 110-2, . . . , 110-M rather than providing a lesser amount of memory resources specifically dedicated to each of the number of register block instances 110-1, 110-2, . . . , 110-M. Thus, the bulk of memory resources provided on the multi-host management device 104 can support a video controller (e.g., a legacy I/O device 112-1, 112-2, . . . , 112-M) in the number of register block instances 110-1, 110-2, . . . , 110-M. In such an example, registers can exist in the register block instances 110-1, 110-2, . . . , 110-M (e.g., registers that are not exposed to the host instances 102-1, 102-2, . . . , 102-N) to map the legacy I/O device 112-1, 112-2, . . . , 112-M to a range of memory contained in the bulk memory resources of the multi-host management device 104.

The multi-host management device 104 can manage the multiple host instances 102-1, 102-2, . . . , 102-N (e.g., can manage multiple physical server instances and/or multiple virtual server instances). Some examples of managing the multiple host instances 102-1, 102-2, . . . , 102-N include monitoring each of the host instances 102-1, 102-2, . . . , 102-N for reset, power, and thermal status, among others. Managing the multiple host instances 102-1, 102-2, . . . , 102-N can include providing remote access and control over the host instances 102-1, 102-2, . . . , 102-N (e.g., via network interface 108). An example of managing the multiple host instances 102-1, 102-2, . . . , 102-N includes providing a system read only memory (ROM) image to at least one of the host instances 102-1, 102-2, . . . , 102-N via the multi-host management device 104. Other examples include providing a mass storage device to a number of the host instances 102-1, 102-2, . . . , 102-N through legacy I/O devices 112-1, 112-2, . . . , 112-M (e.g., a legacy I/O device 112-1 can create a universal host controller interface, UHCI, an enhanced host controller interface, EHCI, an extensible host controller interface, xHCI, for universal serial bus USB, among others, to instructions executing on a logically assigned host instance 102-1, 102-2, . . . , 102-N). That is, the multi-host management device 104 can create a virtual host controller through a number of legacy I/O devices 112-1, 112-2, . . . , 112-M.

In some examples, the communication interconnect 106 can be a single switched fabric between the host instances 102-1, 102-2, . . . , 102-N and the multi-host management device 104. In such examples, communication interconnect cycles of the host instances 102-1, 102-2, . . . , 102-N can be combined onto the single switched fabric to facilitate communication with and control of the multiple host instances 102-1, 102-2, . . . , 102-N by the multi-host management device 104. Such examples can be beneficial in providing for host device emulation and implementation (e.g., by the number of legacy I/O devices 112-1, 112-2, . . . , 112-M associated with the plurality of host register block instances 110-1, 110-2, . . . , 110-M) across the plurality of host instances 102-1, 102-2, . . . , 102-N.

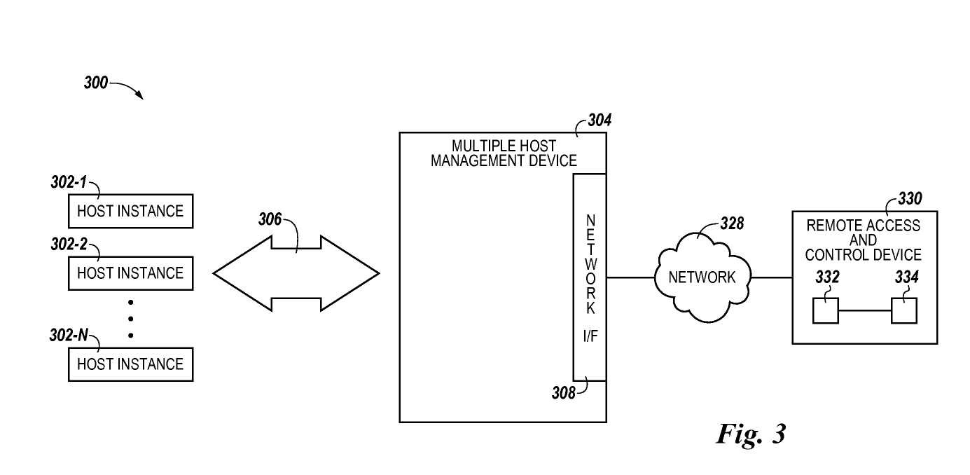

The network interface 108 can provide connectivity to a network (e.g., an intranet, the Internet, etc.) to provide remote access and control over the host instances 102-1, 102-2, . . . , 102-N. For example, an administrator can remotely log in to the multi-host management device 104 to gain access to and control over the host instances 102-1, 102-2, . . . , 102-N, as is described in more detail with respect to FIG. 3.

FIG. 2A illustrates a block diagram of an example of a system 200A for multiple host management including multiple buses according to the present disclosure. The system 200A can include multiple host instances 202-1, 202-2, . . . , 202-N (e.g., analogous to the host instances 102-1, 102-2, . . . , 102-N illustrated in FIG. 1). The system 200A can include a multi-host management device 204 (e.g., analogous to the multi-host management device 104 illustrated in FIG. 1) coupled to the host instances 202-1, 202-2, . . . , 202-N by a communication interconnect 206A.

The multiple host instances 202-1, 202-2, . . . , 202-N can be server nodes. The communication interconnect 206A can include a switched fabric 224 coupled to the host instances 202-1, 202-2, . . . , 202-N, where the switched fabric 224 comprises a respective bus for each of the host instances 202-1, 202-2, . . . , 202-N (e.g., as indicated by the arrows within the switched fabric 224 as illustrated in FIG. 2A).

The multi-host management device 204 can include a plurality of host register block instances 210-1, 210-2, . . . , 210-M (e.g., analogous to the plurality of host register block instances 110-1, 110-2, . . . , 110-M illustrated in FIG. 1). Although not specifically illustrated, each of the plurality of host register block instances 210-1, 210-2, . . . , 210-M can include a number of I/O devices (e.g., legacy I/O devices 112-1, 112-2, . . . , 112-M as illustrated in FIG. 1).

The communication interconnect 206A can include a communication interconnect interface 222-1, 222-2, . . . , 222-M for each respective register block instance 210-1, 210-2, . . . , 210-M as components of the multi-host management device 204. The communication interconnect interfaces 222-1, 222-2, . . . , 222-M can be communicatively coupled to each host register block instance 210-1, 210-2, . . . , 210-M and to the switched fabric 224 for communication with the plurality of host instances 202-1, 202-2, . . . , 202-N. In some examples of the present disclosure, the switched fabric 224 can include a separate bus for each host instance, as illustrated.

The multi-host management device 204 can include a management processor subsystem 214 coupled to the host register block instances 210-1, 210-2, . . . , 210-M. The management processor subsystem can include a number of management processors 216 coupled to a memory controller 218. The memory controller 218 can include or be coupled to memory resources (not specifically illustrated). Memory resources can include memory addressable by the management processor 216. The memory resources can include volatile and/or non-volatile memory such as random access memory (RAM), magnetic memory such as a hard disk, floppy disk, and/or tape memory, a solid state drive (SSD), flash memory, phase change memory, etc. The memory resources can be located on the management processor subsystem 214 and/or on the multi-host management device 204 external to the management processor subsystem 204. The memory controller 218 can be coupled to a network controller 220. As described above, the register blocks 210-1, 210-2, . . . , 210-M can include a number of I/O devices (e.g., legacy I/O devices 112-1, 112-2, . . . , 112-M illustrated in FIG. 1). Some I/O devices can include a unique port into the memory controller 218.

The management processor 216 can be coupled to the network controller 220 (e.g., an Ethernet controller) and can configure the network controller 220. The network controller 220 can transfer packets to and from the memory resources via the memory controller 218. The network controller 220 can be coupled to a network interface 208 (e.g., analogous to network interface 108 illustrated in FIG. 1). The management processor 216 can communicate with the network controller 220, which can transfer packets in and/or out of the management processor subsystem 214 via the network interface 208. Although the network interface 208 is illustrated as being within the management processor subsystem 214, examples are not so limited, as the physical network interface 208 can be external to the management processor subsystem, while still being on the muli-host management device 204.

The management processor 216 can support multiple simultaneous host instances by instantiating the register block instances 210-1, 210-2, . . . , 210-M and configuring the communication interfaces 222-1, 222-2, . . . , 222-M and the switched fabric 224 to establish connections with the host instances 202-1, 202-2, . . . , 202-N and distribute resources thereto. The management processor 216 can provide the system ROM image, as described herein, via the communication interconnect interfaces 222-1, 222-2, . . . , 222-M to the host instances 202-1, 202-2, . . . , 202-N.

The network controller 220 can provide remote access and control over the host instances 202-1, 202-2, . . . , 202-N via the multi-host management device 204. The memory controller 218 can maintain a state for each of the plurality of host instances 202-1, 202-2, . . . , 202-N associated with the multi-host management device 204 via the communication interconnect interfaces 222-1, 222-2, . . . , 222-M. As such, the multi-host management device 204 can assign a portion of the memory resources available to the multi-host management device 204 to a host register block instance 210-1, 210-2, . . . , 210-M. Memory resource portions can be assigned based on configuration registers included in the register block instances 210-1, 210-2, . . . , 210-M.

FIG. 2B illustrates a block diagram of an example of a system 200B for multiple host management including a shared bus according to the present disclosure. The system 200B can include multiple host instances 202-1, 202-2, . . . , 202-N (e.g., analogous to the host instances 102-1, 102-2, . . . , 102-N illustrated in FIG. 1). The system 200B can include a multi-host management device 204 (e.g., analogous to the multi-host management device 104 illustrated in FIG. 1) coupled to the host instances 202-1, 202-2, . . . , 202-N by a communication interconnect 206B.

The multiple host instances 202-1, 202-2, . . . , 202-N can be server nodes. The communication interconnect 206B can include a switched fabric coupled to the host instances 202-1, 202-2, . . . , 202-N, where the switched fabric comprises one bus shared by the host instances 202-1, 202-2, . . . , 202-N collectively.

The multi-host management device 204 can include a plurality of host register block instances 210-1, 210-2, . . . , 210-M (e.g., analogous to the plurality of host register block instances 110-1, 110-2, . . . , 110-M illustrated in FIG. 1). Although not specifically illustrated, each of the plurality of host register block instances 210-1, 210-2, . . . , 210-M can include a number of I/O devices (e.g., legacy I/O devices 112-1, 112-2, . . . , 112-M as illustrated in FIG. 1).

The communication interconnect 206B can include a communication interconnect interface 222B as a component of the multi-host management device 204. The communication interconnect interface 222B can be communicatively coupled to each host register block instance 210-1, 210-2, . . . , 210-M and to a switched fabric 226 for communication with the plurality of host instances 202-1, 202-2, . . . , 202-N. In some examples of the present disclosure, the switched fabric 226 can include a single bus that is used for communication with all of the plurality of host instances 202-1, 202-2, . . . , 202-N, as illustrated. The switched fabric 226 can perform address augmentation and decoding to allow a host instance (e.g., host instance 202-1) to be independently operationally coupled to a register block (e.g., register block 210-1). For example, the switched fabric 226 can encapsulate packets originating from each host instance 202-1, 202-2, . . . , 202-N with identifiers that can be used to direct traffic to the specific addressed register block 210-1, 210-2, . . . , 210-M through the communication interface 222B. Response traffic can be encapsulated by communication interface 222B so that the switched fabric 226 can direct traffic to the addressed host instance 202-1, 202-2, . . . , 202-N. Thus, the host instances 202-1, 202-2, . . . , 202-N can be operationally coupled to the corresponding register blocks 210-1, 210-2, . . . , 210-M through a shared communication fabric (switched fabric 226).

The multi-host management device 204 can include a management processor subsystem 214 coupled to the host register block instances 210-1, 210-2, . . . , 210-M. The management processor subsystem 214 can be analogous to the management processor subsystem 214 illustrated in FIG. 2A (e.g., including a number of management processors 216 coupled to a network interface 208, a memory controller 218, and/or a network controller 220).

FIG. 3 illustrates a block diagram of an example of a system 300 for multiple host management including remote access and control according to the present disclosure. The system 300 can include multiple host instances 302-1, 302-2, . . . , 302-N (e g., analogous to the host instances 102-1, 102-2, . . . , 102-N illustrated in FIG. 1). The system 300 can include a multi-host management device 304 (e.g., analogous to the multi-host management device 104 illustrated in FIG. 1) coupled to the host instances 302-1, 302-2, . . . , 302-N by a communication interconnect 306. The multi-host management device 304 can also be coupled to a network 328 (e.g., an intranet, the Internet, etc.) by a network interface 308. In some examples, the network interface 308 can be used to couple the multi-host management device 304 both to the network 328 and to the plurality of host instances 302-1, 302-2, . . . , 302-N via the communication interface 306. However, examples are not so limited, as the network interface 308 can provide a different communication means than that provided for the communication interface 306 (e.g., a communication interconnect interfaces 222-1, 222-2, . . . , 222-M and/or 222B as illustrated in FIGS. 2A-2B).

A remote access and control device 330 may be coupled to the network 328. Thus, the remote access and control device 330 (e.g., a computing device) may be communicatively coupled with the multi-host management device 304. The remote access and control device can include processor resources 332 and memory resources 334 for reading and executing computer executable instructions. The remote access and control device can be used for remotely managing and controlling multiple host instances 302-1, 302-2, . . . , 302-N via the multiple host management device 304 as described herein.

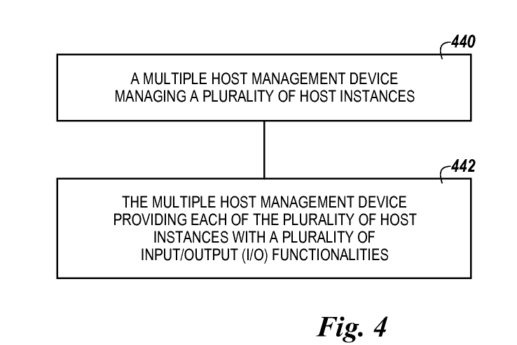

FIG. 4 provides a block diagram illustrating an example of a method for multiple host management according to the present disclosure. A multi-host management device can manage 440 a plurality of host instances. The multi-host management device can provide 442 each of the plurality of host instances with a plurality of I/O functionaRies.

It is to be understood that the above description has been made in an illustrative fashion, and not a restrictive one. Although specific examples have been illustrated and described herein, other component arrangements, instructions, and/or device logic can be substituted for the specific examples shown.

What is claimed:

1. A method for multiple host management, comprising:
a multiple host management device managing a plurality of host instances; and
the multiple host management device providing each of the plurality of host instances with a plurality of input/output (I/O) functionalities.

2. The method of claim 1, wherein providing each of the plurality of host instances with the plurality of 1/0 functionalities includes supporting the plurality of I/O functionalities with a plurality of host register block instances on the multiple host management device.

3. The method of claim 2, wherein:
managing the plurality of host instances comprises managing physical server instances; and
providing each of the plurality of host instances with the plurality of I/O functionalities includes providing 1/0 functionalities selected from the group of I/O functionalities including:
keyboard communication;
video communication;
mouse communication;
serial communication; and
mass storage.

4. The method of claim 2, wherein the method includes the multiple host management device assigning a portion of memory resources of the multiple host management device to one of the plurality of host register block instances.

5. The method of claim 1, wherein managing the plurality of host instances includes monitoring each of the plurality of host instances for reset, power, and thermal status.

6. The method of claim 1, wherein managing the plurality of host instances includes providing remote access and control over the plurality of host instances.

7. The method of claim 1, wherein managing the plurality of host instances includes the multiple host management device providing a system read only memory (ROM) image to at least one of the plurality of host instances.

8. The method of claim 1, wherein the method includes combining communication interconnect cycles of the plurality of host instances onto a single switched fabric between the plurality of host instances and the multiple host management device.

9. A multiple host management device, comprising:
a communication interconnect interface;
a plurality of host register block instances each coupled to the communication interconnect interface and each including a plurality of legacy input/output (I/O) devices; and
a management processor subsystem coupled to the plurality of host register block instances.

10. The device of claim 9, wherein the management processor subsystem includes:
a management processor to provide a system read only memory (ROM) image via the communication interconnect interface; and
an Ethernet controller to provide remote access and control via the multiple host management device.

11. The device of claim 9, further including a memory controller to maintain a state for each of a plurality of host instances associated with the multiple host management device via the communication interconnect interface.

12. A multiple host management system, comprising:
a communication interconnect;
a plurality of host instances coupled to the communication interconnect;
a multiple host management device coupled to the communication interconnect, the multiple host management device including:
a plurality of host register block instances each including a plurality of legacy input/output (I/O) devices to provide I/O functionality to each of the plurality of host instances; and
a network interface to provide remote access and control over the plurality of host instances.

13. The system of claim 12, wherein:
the plurality of host instances comprise a plurality of server nodes coupled to a backplane, at least one of the plurality of server nodes not including legacy I/O hardware; and
the backplane is coupled to the communication interconnect and the multiple host management device.

14. The system of claim 13, wherein:
the plurality of server nodes include a plurality of physical server nodes; and
the communication interconnect includes a switched fabric coupled to the plurality of physical server nodes, the switched fabric comprising a respective bus for each of the plurality of physical server nodes.

15. The system of claim 13, wherein:
the plurality of server nodes include a plurality of virtual server nodes; and
the communication interconnect includes a switched fabric coupled to the plurality of virtual server nodes, the switched fabric comprising by one bus shared by the plurality of physical server nodes.
